(19) United States
(12) Patent Application Publication
(10) Pub. No.: US 2003/0069932 A1
(43) Pub. Date: Apr. 10, 2003

(54) System and method for providing transmission notification

(76) Inventors: John M. Hall, Boise, ID (US); Craig McCoy, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/974,064

(22) Filed: Oct. 10, 2001

(51) Int. Cl. G06F 15/173

(52) U.S. Cl. 709/206; 709/238

(57) ABSTRACT

The present disclosure relates to a system and method for providing transmission notification. More particularly, the present disclosure relates to providing notification to a user that a document has been transmitted with a transmission device. In one arrangement, the system and method pertain to identifying the location of an email account of the user and sending a copy of the transmitted document to the user email account. In another arrangement, the system and method pertain to identifying the location of an email account of the user and sending a notification to the user email account.

### FIELD OF THE INVENTION

The present disclosure relates to a system and method for providing transmission notification. More particularly, the disclosure relates to a system and method with which a transmission notification can be delivered to a sender's email account.

### BACKGROUND OF THE INVENTION

Traditionally, email programs that execute on a computing device have been configured to provide notifications of what email messages have been sent from the computing device. With such operation, the user can immediately determine what email messages he or she has sent as well as review the contents of the messages.

Recently, various independent transmission devices have been produced that are capable of sending email messages as well as facsimile messages. For example, malfunction devices, sometimes referred to as multifunction peripherals (MFPs) or all-in-ones, can be used in shared user environments to send documents to designated recipients. Although providing another means for transmitting documents, such devices do not currently provide convenient notification means that permit the user to review the documents that have been sent by the user. For example, where the device is used to fax a document, the user typically only receives a facsimile confirmation notice printed by the device that verifies that the facsimile was transmitted. As for emailed documents, some multifunction devices are capable of delivering notifications that transmitted email documents have been received by the recipient, but such devices do not provide the user with immediate notice of what was transmitted. Moreover, such devices do not provide the user with a copy of the emailed document.

In view of the notification limitations noted above, it can be appreciated that it would be desirable to have a system and method with which notifications similar to those obtained through conventional email applications can be provided to the user where a document has been transmitted by an independent transmission device.

### SUMMARY OF THE INVENTION

The present disclosure relates to a system and method for providing transmission notification. More particularly, the present disclosure relates to providing notification to a user that a document has been transmitted with a transmission device.

In one arrangement, the system and method pertain to identifying an email account of the user and sending a copy of the transmitted document to the user email account.

In another arrangement, the system and method pertain to identifying an email account of the user and sending a notification to the user email account.

The disclosure further relates to transmission devices. In one arrangement, the transmission device comprises a processing device and memory including a notification module that is configured to send a copy of documents transmitted by the transmission device to an email account of the document sender.

In another arrangement, the transmission device comprises a processing device and memory including a notification module that is configured to send a notification that a document was faxed by the transmission device to an email account of the facsimile document sender.

The features and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view of an example system in which the invention can be implemented.

FIG. 2 is a schematic view of a transmission device shown in FIG. 1.

FIG. 3 is a schematic view of a computing device shown in FIG. 1.

FIG. 4 is a flow diagram that illustrates operation of a transmission control module of the transmission device shown in FIG. 2.

FIG. 5 is a flow diagram that illustrates operation o f a notification module of the transmission device shown in FIG. 2.

### DETAILED DESCRIPTION

As noted above, disclosed is a system and method for providing transmission notification. To facilitate description of the system and method, an example system will first be discussed with reference to the figures. Although this system is described in detail, it will be appreciated that this system is provided for purposes of illustration only and that various modifications are feasible without departing from the inventive concept. After the example system has been described, examples of operation of the system will be provided to explain the manners in which effective transmission notification can be obtained.

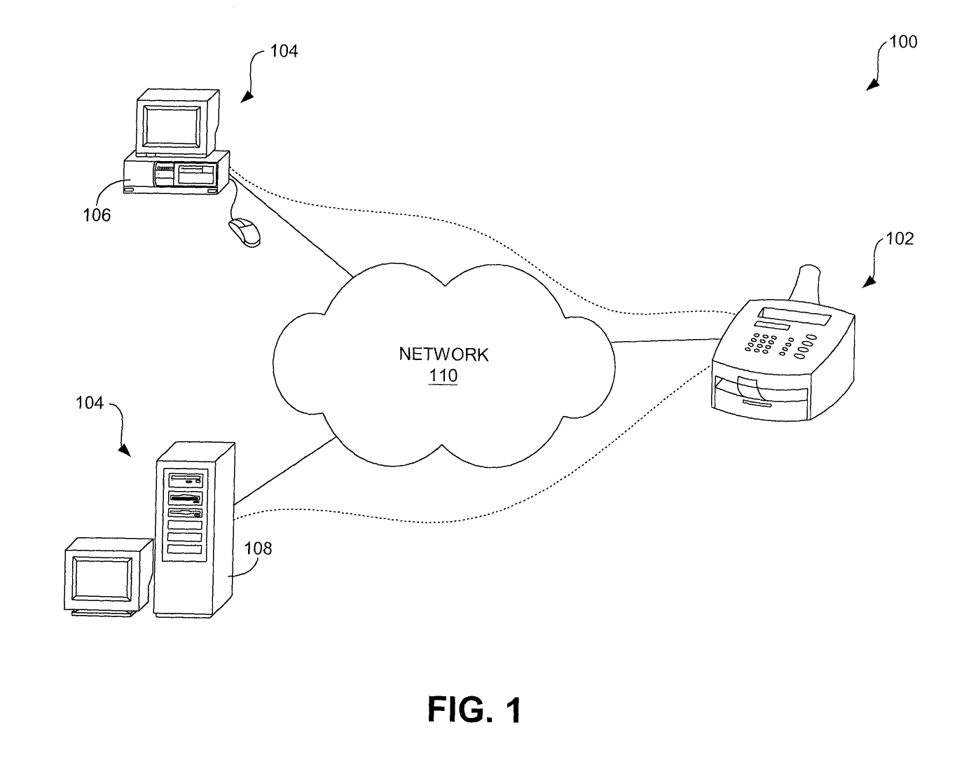

Referring now in more detail to the drawings, in which like numerals indicate corresponding parts throughout the several views, FIG. 1 illustrates an example system 100. As indicated in this figure, the system 100 generally comprises a transmission device 102 that is capable as operating as a peripheral device and/or as a stand-alone (walk-up) device. Generally speaking, the transmission device 102 comprises a device that is capable of transmitting documents to a destination device. For instance, the transmission device 102 is capable of faxing data, emailing data, or both. Typically, the transmission device 102 is also configured to receive data (e.g., faxed, emailed, or both) transmitted by other devices. By way of example, the transmission device 102 can comprise a multifunction peripheral (MFP).

In addition to the transmission device 102, the system 100 can include one or more computing devices 104. The computing devices 104 comprise any device that is capable of receiving data from the transmission device 102, either directly from the transmission device or indirectly from another device and, typically, which can transmit data to the transmission device. By way of example, the computing devices 104 can comprise a personal computer (PC) 106 and a network server 108. Although a PC 106 and a server 108 are identified in FIG. 1 and discussed herein, it will be appreciated that any one of the computing devices 104 could, alternatively, comprise another type of computing device including, for instance, notebook computers, personal digital assistants (PDAs), mobile telephones, etc. As is discussed below, the computing devices 104 can receive notifications transmitted by or for the transmission device 102, facilitate transmission of such notifications to another computing device, or both.

As is further identified in FIG. 1, the transmission device 102 and the computing devices 104 can, optionally, be connected to a network 110 that typically comprises one or more sub-networks that are communicatively coupled to each other. By way of example, these networks can include one or more local area networks (LANs) and/or wide area networks (WANs). Indeed, in some embodiments, the network 110 may comprise a set of networks that forms part of the Internet. As is depicted in FIG. 1, one or more of the computing devices 104 can be directly connected to the transmission device 102. Such an arrangement is likely in a home environment in which the user does not have a home network or in an office environment where the transmission device 102 is used as a local “convenience” device. In such a scenario, communication can be facilitated with a direct electrical and/or optical connection or through wireless communication.

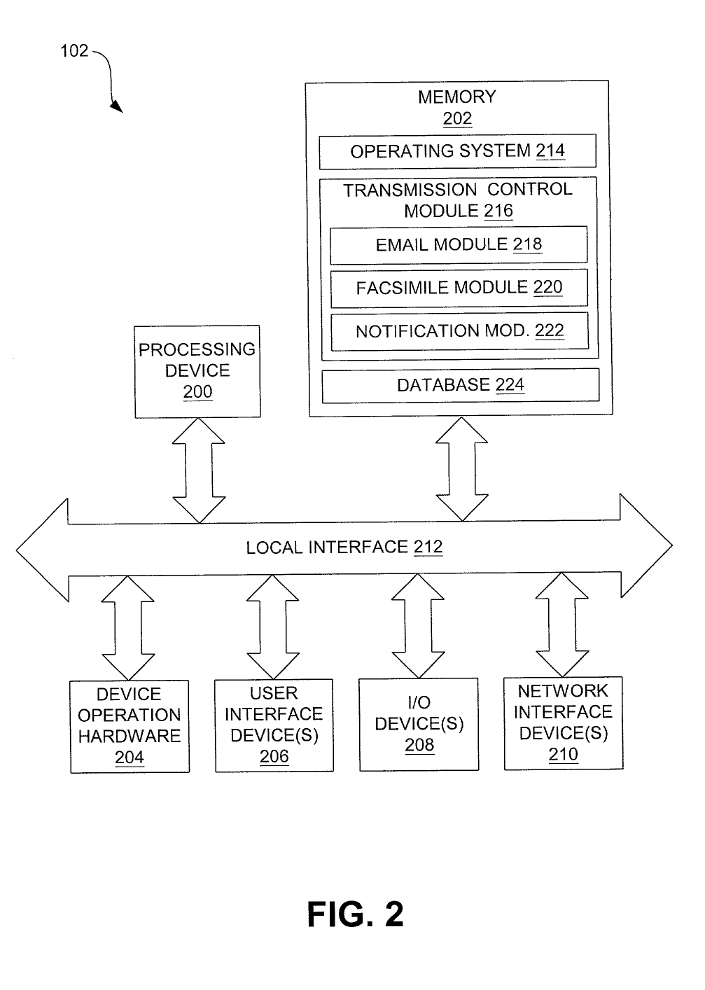

FIG. 2 is a schematic view illustrating an example architecture for the transmission device 102 shown in FIG. 1. As indicated in FIG. 2, the transmission device 102 can comprise a processing device 200, memory 202, device operation hardware 204, one or more user interface devices 206, one or more input/output (I/O) devices 208, and one or more network interface devices 210. Each of these components is connected to a local interface 212 that, by way of example, comprises one or more internal buses. The processing device 200 is adapted to execute commands stored in memory 202 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the transmission device 102.

The device operation hardware 204 comprises the various components with which the core functionalities of the transmission device 102 are facilitated. For example, where the transmission device 102 is designed to transmit facsimile and email documents, the transmission device comprise comprises the various components that facilitate such transmission. Where the transmission device 102 is configured for facsimile transmission, the hardware 204 may further include a scanning mechanism. The one or more user interface devices 206 typically comprise interface tools with which the device settings can be changed and through which the user can directly communicate information and commands to the transmission device 102. By way of example, the user interface devices 206 comprise one or more function keys and/or buttons with which the operation of the transmission device 102 can be controlled and a plurality of numeric and/or alphabetic keys or buttons that can be used to input information. In addition, the user interface devices 206 can comprise a display with which text and/or graphics can be presented to the user. Such a display can, for instance, comprise a liquid crystal display (LCD), a light emitting diode (LED) display, plasma screen, etc. Optionally, the display can be touch-sensitive such that user commands and selections can be entered with the display.

With further reference to FIG. 2, the one or more I/O devices 208 are adapted to facilitate connection of the transmission device 102 to another device, such as a computing device 104, and may therefore include one or more serial, parallel, small computer system interface (SCSI), universal serial bus (USB), IEEE 1394 (e.g., Firewire™), and/or personal area network (PAN) components. The network interface devices 210 comprise the various components that are used to transmit and/or receive data over the network 110. By way of example, the network interface devices 210 include a device that can communicate both inputs and outputs, for instance, a modulator/demodulator (e.g., modem), wireless (e.g., radio frequency (RF)) transceiver, a telephonic interface, a bridge, a router, network card, etc.

The memory 202 includes various software and/or firmware programs including an operating system 214 and a transmission control module 216. The operating system 214 contains the various commands used to control the general operation of the transmission device 102. The transmission control module 216 comprises the various software and/or firmware that controls transmissions from the device 102. As indicated in FIG. 2, the transmission control module 216 can include an email module 218, a facsimile module 220, and a notification module 222. The purpose of these various modules will become apparent from the discussions that follow. In addition to the operating system 214 and the transmission control module 216, the memory 202 can, optionally, include a database 224 that can be used to look-up various user information including, for instance, the location of the user's (i.e., sender's) email account, etc. Although shown as forming part of the transmission device 102, persons having ordinary skill in the art will appreciate that this database could, alternatively, be located on another device such as a network server (e.g., server 108).

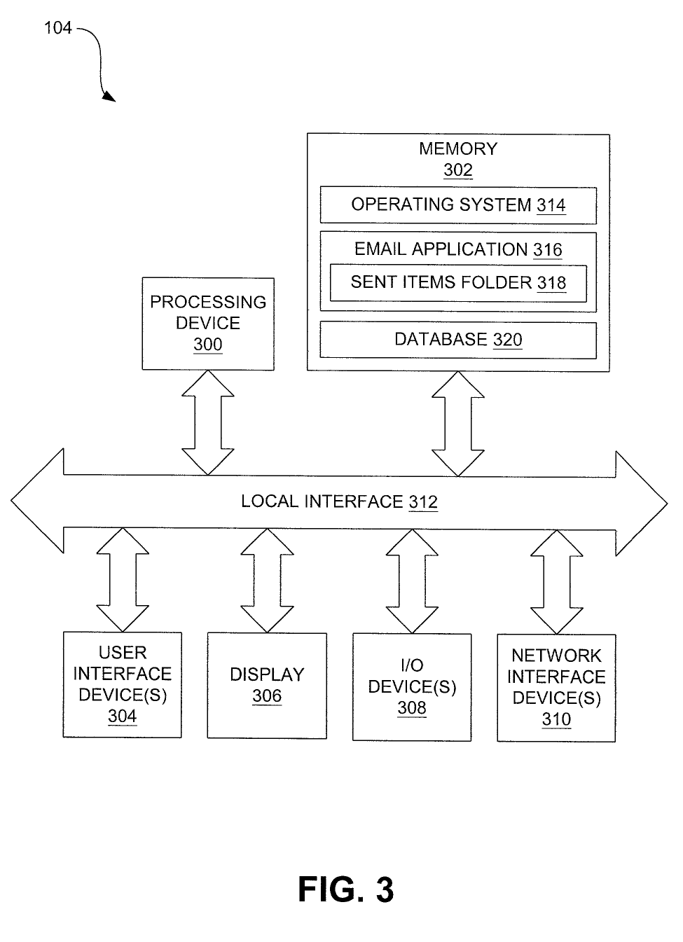

FIG. 3 is a schematic view illustrating an example architecture for the computing devices 104 shown in FIG. 1. As indicated in FIG. 3, each computing device 104 can comprise a processing device 300, memory 302, one or more user interface devices 304, a display 306, one or more I/O devices 308, and one or more networking devices 310, each of which are connected to a local interface 312. The processing device 300 can include any custom made or commercially available processor, a central processing unit (CPU) or an auxiliary processor among several processors associated with the computing device 104, a semiconductor based microprocessor (in the form of a microchip), or a macroprocessor. The memory 302 can include any one of a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 304 comprise those components with which the user can interact with the computing device 104. For example, where the computing device 104 comprises a PC or server, these components can comprise a keyboard, mouse, and/or track ball. Where the computing device 104 comprises a handheld device (e.g., PDA, mobile telephone), these components can comprise function keys or buttons, a touch-sensitive screen, etc. The display 306 can comprise a computer monitor or plasma screen for a PC, or a liquid crystal display (LCD) for a handheld device. The one or more P/O devices 308 and the one or more network interface devices 310 operate and can have similar configuration to the like-named components described above with relation to FIG. 2.

The memory 302 normally, at minimum, comprises an operating system 314 and an email application 316. The operating system 314 controls the execution of other software and provides scheduling, input-output control, file and data management, memory management, and communication control and related services. As its name suggests, the email application 316 comprises a user application that executes on the computing device 104 to send and receive email messages (i.e., documents). As identified in FIG. 3, the email application 316 at least comprises a sent items folder 318 in which email messages that the user has transmitted can be cached or stored. Typically, the email application 316 further comprises a graphical user interface (GUI) (not identified) with which the user can compose, review, and transmit email messages as desired. In addition to the software identified above, the memory 302 may comprise a database 224 that contains information about the user Alsuch as the user's identity, the location of the user's email account, etc.

Various software and/or firmware programs have been described herein. It is to be understood that these programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

An example system 100 having been described above, operation of the system will now be discussed. In the discussion that follows, flow diagrams are provided. It is to be understood that any process steps or blocks in these flow diagrams represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

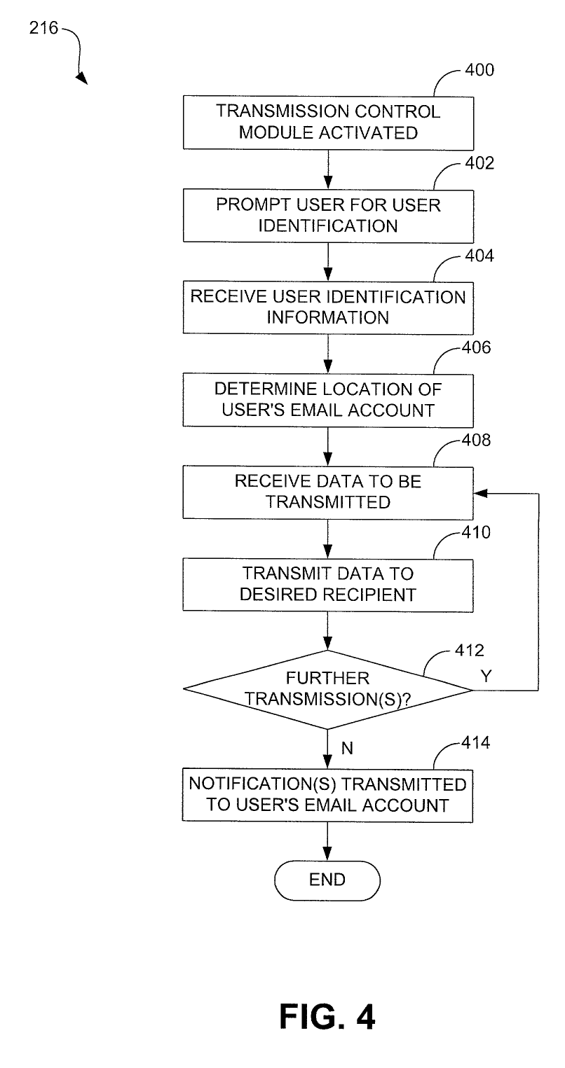

Referring to FIG. 4, an example of operation of the transmission control module 216 operating in a notification capacity will be described. Beginning with block 400, the transmission control module 216 is activated. This activation occurs when the transmission device 102 is first accessed by a user and called upon to transmit data to an intended recipient. As noted above, the transmission can comprise, for example, an email transmission or a facsimile transmission. Irrespective of the type of transmission that is desired, the user can be prompted to provide a user identity, as indicated in block 402. By way of example, the process can comprise prompting the user to log in with the transmission device 102 through entry of a user name and password. Such a procedure identifies the user to the device 102 and, in some arrangements, can be used to provide security over use of the device where it is desired that only certain, authorized users are to be permitted to access and use the device. Although the operation of the transmission control module 216 has been described herein as comprising an identification (e.g., log in) procedure, it is to be understood that such a procedure may not be necessary, particularly in an environment where the transmission device 102 is not shared with multiple persons.

Once the user identity information has been entered, it is received by the transmission control module 216, as indicated in block 404. Next, the transmission control module 216 can determine the location of the user's email account for the user who, in this case, will be the sender of the data that is to be transmitted. This determination can be made in a variety of different ways. In one arrangement, the transmission control module 216 can access user specific data contained within the transmission device database 224. More particularly, the transmission control module 216 can use the user identity information (e.g., user name) to identify the location of that user's email account in a look-up table or other device. In another arrangement, the responsibility for making the identification can be passed to another device, for instance a network server that is connected to the network 110 (e.g., server 108). In such a case, the user information can be forwarded on to the other device that stores this information in an email account database. The other device can then determine the location of the user's email account by, for example, creating a messaging application programming interface (MAPI) profile, which is used to obtain information as to the location of the user's email account. Using the network server 108 as an example, this information can be stored in the database 320 of the other device.

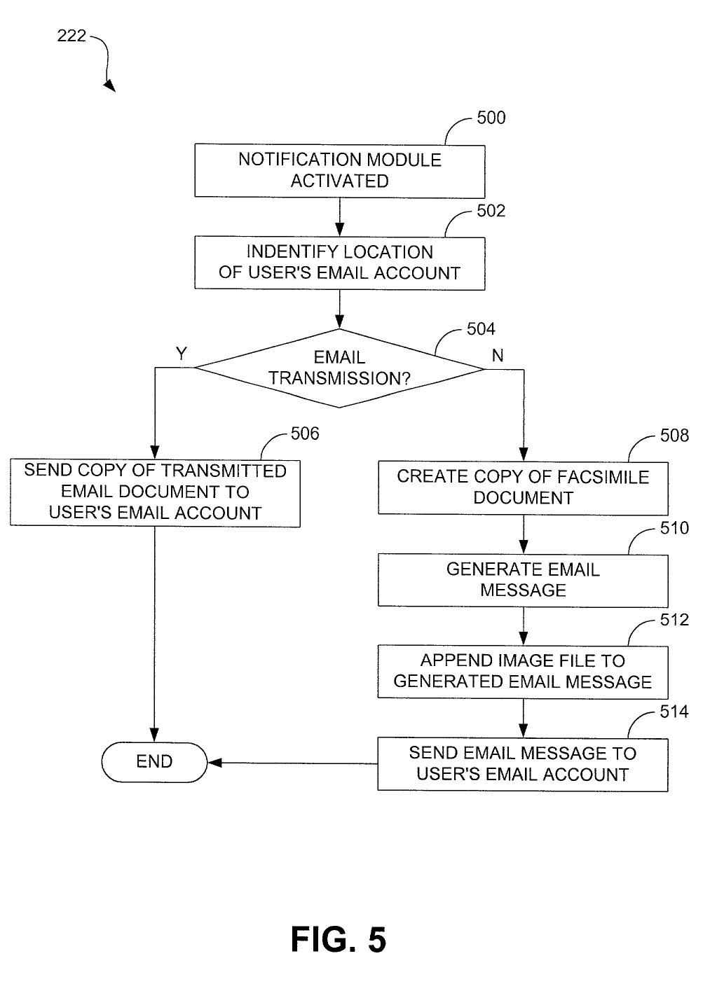

Once the email account has been identified, regardless of the manner in which the identification was made, the transmission control module 216 can receive the data that are to be transmitted to the intended recipient, as indicated in block 408. These data can comprise text that is entered directly into the transmission device 102 by the user (e.g., via the user interface devices 206), text and/or images that are forwarded to the transmission device from another device for email or facsimile transmission, text and/or images obtained through scanning a hard copy document to be transmitted, etc. After the data have been received, the data can be transmitted in the appropriate format to the desired recipient, as indicated in block 410. Again, as noted above, transmission can be through a variety of different methods including, for example, email, facsimile, etc. At this point, it can be determined whether further transmissions are to be made, as indicated in decision element 412. If not, flow for the notification session is terminated. If further transmissions are to be made, however, flow returns to block 408 at which the data to be transmitted is received in the manner described above. Before, during, or after the transmission(s) has/have occurred, a notification can be transmitted to the user's (i.e., sender's) email account, as indicated in block 414. Examples of the nature of the notification are provided below with regard to FIG. 5 which describes an example of operation of the notification module 222.

Turning to FIG. 5, an example of operation of the notification module 222 of the transmission control module 216 will be discussed. Beginning with block 500, the notification module 222 is first activated. As implied above, this activation can occur when a transmission (e.g., email or facsimile transmission) is about to be, is being, or has already been made by the transmission device 102. Once activated, the notification module 222 identifies the user's (i.e., sender's) email account, as indicated in block 502, which was determined or received by the transmission control module 216 in the manner described above in relation to FIG. 4. At this point, the notification module 222 can determine whether the transmission is/was an email transmission (versus some other type of transmission), as indicated in decision element 504. If the transmission is/was an email transmission, the notification module 222 sends a copy of the email transmission to the user's email account, as indicated in block 506. More particularly, the notification module 222 sends a copy of the transmitted email to the sent items folder 318 of the user's email application 316 that executes on the user's computing device 104. Operating in this manner, the notification module 222 can be used to obtain the same notification functionality obtained from conventional email applications that execute on user computing devices.

With reference back to decision element 504, if the transmission is not an email transmission, flow continues to block 508. It is noted that, for the remainder of the discussion of FIG. 5, it is assumed that the transmission device 102 only has email and facsimile transmission capabilities. Accordingly, where transmission is not via email, facsimile transmission is assumed. However, persons having ordinary skill in the art will appreciate that other forms of transmission may be used, where available. Where the transmission is a facsimile transmission, a copy of the facsimile document is created as an image file, as indicated in block 508. Preferably, the image file format comprises a format that is widely used at the time the transmission is made such that the file can be opened by most users. For instance, the image file format can comprise one or more of JPEG, TIFF, MTIFF, PDF, GIF, BMP, etc.

Once the copy of the facsimile document has been created, the notification module 222 can generate an email message, as indicated in block 510, which is directed toward the user who transmitted the facsimile document. Next, with reference to block 512, the copy (i.e., image file) is appended to the generated email message and, as indicated in block 514, the email message is sent to the user's email account. More specifically, the message is sent to the sent items folder 318 of the user's computing device. Operating in this manner, the notification module 222 can be used to obtain a transmission notification for transmitted facsimile documents that includes a copy of the facsimile document itself. Accordingly, the user can have a single location with which he or she can identify and review transmissions the user has sent, regardless of the location from which the transmission originated and irrespective of the transmission method (e.g., email or facsimile) that was used.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for providing notification to a user that a document was transmitted with a transmission device, comprising the steps of:
identifying the location of an email account of the user; and
sending a copy of the transmitted document to the user email account.

2. The method of claim 1, wherein the step of identifying the location of an email account of the user comprises identifying the location of the email account from user identity information entered into the transmission device.

3. The method of claim 1, wherein the step of sending a copy of the transmitted document comprises sending a copy of the transmitted document to a sent items folder of a user email application.

4. The method of claim 3, wherein the user email application executes on a separate computing device.

5. The method of claim 1, wherein the document has been transmitted by the transmission device via email.

6. The method of claim 1, wherein the document has been transmitted by the transmission device via facsimile.

7. The method of claim 6, wherein the step of sending a copy of the transmitted document comprises creating a copy of a facsimile document, appending the created copy to an email message, and sending the email message to the user email account.

8. A system for providing notification to a user that a document was transmitted with a transmission device, comprising:
means for identifying the location of an email account of the user; and
means for sending a copy of the transmitted document to the user email account.

9. The system of claim 8, wherein the means for identifying the location of an email account of the user comprise means for identifying the location of the email account from user identity information entered into the transmission device.

10. The system of claim 8, wherein the means for sending a copy of the transmitted document comprise means for creating a copy of a facsimile document, appending the created copy to an email message, and sending the email message to the user email account.

11. A transmission device, comprising:
a processing device; and
memory including a notification module that is configured to send a copy of documents transmitted by the transmission device to an email account of the document sender.

12. The transmission device of claim 11, wherein the notification module is configured to send a copy of documents that were transmitted via email to the email account.

13. The transmission device of claim 11, wherein the notification module is configured to send a copy of documents that were transmitted via facsimile to the email account.

14. The transmission device of claim 13, wherein the notification module is further configured to create a copy of facsimile documents, append them to email messages, and send the email messages containing the appended copies to the email account.

15. The transmission device of claim 11, wherein the transmission device is a multifunction peripheral (MFP).

16. A method for providing notification to a user that a document was faxed with a transmission device, comprising the steps of:
identifying the location of an email account of the user; and
sending a notification to the user email account.

17. The method of claim 16, wherein the step of identifying the location of an email account of the user comprises determining the location of the email account from user identity information entered into the transmission device.

18. The method of claim 16, wherein the step of sending a notification to the user email account comprises sending a copy of the faxed document to the user email account.

19. The method of claim 18, wherein the step of sending a notification further comprises creating a copy of a facsimile document, appending the created copy to an email message, and sending the email message to the user email account.

20. The method of claim 16, wherein the user email application executes on a separate computing device.

21. A system for providing notification to a user that a document was faxed with a transmission device, comprising:
means for identifying the location of an email account of the user; and
means for sending a notification to the user email account.

22. The system of claim 21, wherein the means for identifying the location of the email account of the user comprise means for determining the location of the email account from user identity information entered into the transmission device.

23. The system of claim 21, wherein the means for sending a notification to the user email account comprise means for sending a copy of the faxed document to the user email account.

24. The system of claim 23, wherein the means for sending a notification further comprise means for creating a copy of a facsimile document, appending the created copy to an email message, and sending the email message to the user email account.

25. A transmission device, comprising:
a processing device; and
memory including a notification module that is configured to send a notification that a document was faxed by the transmission device to an email account of the facsimile document sender.

26. The transmission device of claim 25, wherein the notification module is configured to send a copy of the facsimile document to the email account.

27. The transmission device of claim 25, wherein the notification module is further configured to create a copy of facsimile documents, append them to email messages, and send the email messages containing the appended copies to the email account.

28. The transmission device of claim 25, wherein the transmission device is a multifunction peripheral (MFP).
